(19) United States
(12) Patent Application Publication
(10) Pub. No.: US 2025/0355077 A1
(43) Pub. Date: Nov. 20, 2025

(54) RADAR APPARATUS

(71) Applicant: HL KLEMOVE CORPORATION, Incheon (KR)

(72) Inventors: Han Byul LEE, Incheon (KR); Kyung-Jin YOU, Incheon (KR); Jin Gu LEE, Incheon (KR); Jung Hwan CHOI, Incheon (KR); Jae Hyun HAN, Incheon (KR)

(21) Appl. No.: 18/917,117

(22) Filed: Oct. 16, 2024

(30) Foreign Application Priority Data
May 14, 2024 (KR) 10-2024-0063417

(51) Int. Cl. G01S 7/03; H01Q 21/06

(52) U.S. Cl. CPC G01S 7/03; H01Q 21/065

(57) ABSTRACT

The disclosure relates to a technology for arranging antennas of a radar apparatus. Four transmitting antennas include first, second, third, and fourth transmitting antennas sequentially arranged by predetermined first, second, and third separation distances. Four receiving antennas include first, second, third, and fourth receiving antennas sequentially arranged by predetermined fourth, fifth, and sixth separation distances. The predetermined first, third, fourth, and sixth separation distances are set to different numerical values.

### CROSS REFERENCE TO RELATED APPLICATION

This application claims priority from Korean Patent Application No. 10-2024-0063417, filed on May 14, 2024, which is hereby incorporated by reference for all purposes as if fully set forth herein.

### BACKGROUND

### Technical Field

Embodiments relate to an arrangement of antennas in a radar apparatus.

### Description of Related Art

Radar technology is a technology that obtains information about an object, including the type, speed of movement, position, and the like of the object, using a reflection signal transmitted by a radar apparatus, reflected from the object, and then received by the radar apparatus.

Recently, radar technology has been actively developed to detect objects located around a host vehicle for safe operation of the vehicle and to set the driving path of the vehicle based on the result of the detection. This technology may also be applied to advanced driver assistance systems (ADAS), which may allow a driver to take necessary actions based on information detected by sensors mounted on the vehicle, or may allow the vehicle to be controlled automatically to prevent accidents from occurring.

In addition, radar apparatuses require high angle resolution to accurately detect surrounding objects. Conventionally, the number of antennas has been increased in order to increase resolution, but the problem therewith is that the increased number of antennas may increase the size of the radar apparatus.

In particular, automotive radar apparatuses are required to be reduced in size by minimizing the number of antennas while maintaining high resolution, as opposed to military radar apparatuses, each of which may provide high power while having hundreds of receiver channels.

### BRIEF SUMMARY

Embodiments may provide a radar apparatus having a high resolution.

According to an aspect, embodiments provide a radar apparatus including: four transmitting antennas comprising first, second, third, and fourth transmitting antennas sequentially arranged by predetermined first, second, and third separation distances; and four receiving antennas comprising first, second, third, and fourth receiving antennas sequentially arranged by predetermined fourth, fifth, and sixth separation distances, wherein the predetermined first, third, fourth, and sixth separation distances are set to different numerical values.

According to embodiments, the radar apparatus having a high resolution may be provided.

### BRIEF DESCRIPTION OF THE SEVERAL VIEWS OF THE DRAWINGS

The above and other objectives, features, and advantages of the present disclosure will be more clearly understood from the following detailed description, taken in conjunction with the accompanying drawings, in which:

FIG. 1 is a block diagram illustrating the configuration of a radar apparatus according to embodiments;

FIG. 2 is a block diagram illustrating a component added to the radar apparatus according to embodiments;

FIG. 3 is a diagram illustrating an implementation of the configuration of the radar apparatus according to embodiments;

FIG. 4 illustrates an arrangement of transmitting antennas and receiving antenna according to an embodiment;

FIG. 5 illustrates an arrangement of transmitting antennas and receiving antenna according to another embodiment;

FIG. 6 illustrates an arrangement of transmitting antennas and receiving antenna according to another embodiment;

FIG. 7 is a diagram illustrating separation distances of transmitting antennas and receiving antennas according to embodiments;

FIG. 8 illustrates separation distances between transmitting antennas and receiving antennas according to embodiments; and

FIG. 9 illustrates separation distances between transmitting antennas and receiving antennas according to embodiments.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting”, “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after”, “subsequent to”, “next”, “before”, and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

As used herein, the terms “transmitting antenna” and “receiving antenna” refer to antennas radiating radar signals and receiving reflection radar signals reflected from objects, respectively. For example, each of the antennas may be an antenna including one or more patch antennas. In another example, the antenna may be a micro-strip patch antenna. In another example, the antenna may be a waveguide antenna. However, the antenna according to the present disclosure may be configured in various manners without being limited in type as an antenna able to radiate radar signals and receive reflection radar signals reflected from an object.

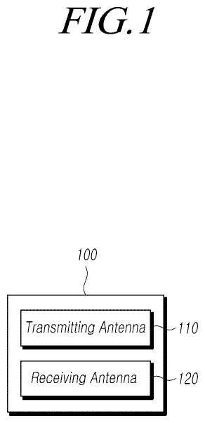

FIG. 1 is a block diagram illustrating the configuration of a radar apparatus according to embodiments.

Referring to FIG. 1, the radar apparatus 100 of the present disclosure includes: four transmitting antennas 110 including first, second, third, and fourth transmitting antennas sequentially arranged by predetermined first, second, and third separation distances; and four receiving antennas 120 including first, second, third, and fourth receiving antennas sequentially arranged by predetermined fourth, fifth, and sixth separation distances.

In an example, the first separation distance between the first transmitting antenna and the second transmitting antenna, the third separation distance between the third transmitting antenna and the fourth transmitting antenna, the fourth separation distance between the first receiving antenna and the second receiving antenna, and the sixth separation distance between the third receiving antenna and the fourth receiving antenna of the present disclosure may be set to have different numerical values.

As described above, there is no limitation on the type of antennas of the four transmitting antennas 110 and the four receiving antennas 120 included in the radar apparatus 100 of the present disclosure.

In another example, each of the four transmitting antennas 110 and the four receiving antennas 120 of the present disclosure may be arranged on respective straight lines to be spaced apart from each other. That is, the four transmitting antennas 110 may be spaced apart from each other on a first straight line. In addition, the four receiving antennas 120 may be spaced apart from each other on a second straight line.

In another example, the four transmitting antennas 110 and the four receiving antennas 120 may be arranged such that the first straight line on which the four transmitting antennas 110 are spaced apart from each other is parallel to the second straight line on which the four receiving antennas 120 are spaced apart from each other.

In another example, at least two of the four transmitting antennas 110 may be spaced apart from the remaining transmitting antennas by a predetermined vertical spacing in the vertical direction. For example, the first transmitting antenna and the second transmitting antenna may be spaced apart from the third transmitting antenna and the fourth transmitting antenna, respectively, by a predetermined vertical spacing in the vertical direction. In another example, the first transmitting antenna, the second transmitting antenna, and the third transmitting antenna may be spaced apart from the fourth transmitting antenna by a predetermined vertical spacing in the vertical direction. Accordingly, any two or three transmitting antennas of the four transmitting antennas 110 may be spaced apart from the remaining transmitting antennas by a predetermined vertical spacing in the vertical direction.

In another example, the four transmitting antennas 110 of the present disclosure may be disposed in a region above or below the four receiving antennas 120 in the vertical direction. That is, all of the four transmitting antennas 110 of the present disclosure may be disposed in a region above the four receiving antennas 120, or all of the four transmitting antennas 110 may be disposed in a region below the four receiving antennas 120.

In addition, the four transmitting antennas 110 of the present disclosure may be arranged such that the antennas have a first separation distance between the first transmitting antenna and the second transmitting antenna, a second separation distance between the second transmitting antenna and the third transmitting antenna, and a third separation distance between the third transmitting antenna and the fourth transmitting antenna.

In an example, the first separation distance, the third separation distance, the fourth separation distance, and the sixth separation distance may be set to different numbers at a predetermined ratio. For example, the first separation distance may be set to be 1, the third separation distance may be set to be 2, the fourth separation distance may be set to be 3, and the sixth separation distance may be set to be 4. The above-described predetermined ratios may be set be various values that vary the first separation distance, the third separation distance, the fourth separation distance, and the sixth separation distance.

In another example, the first separation distance and the third separation distance may be set based on a predetermined transmitting antenna spacing factor and a predetermined unit separation distance.

In addition, the four receiving antennas 110 of the present disclosure may be arranged such that the four receiving antennas have the fourth separation distance between the first receiving antenna and the second receiving antenna, the fifth separation distance between the second receiving antenna and the third receiving antenna, and the sixth separation distance between the third receiving antenna and the fourth receiving antenna.

In an example, the fourth separation distance and the sixth separation distance may be set based on a predetermined receiving antenna spacing factor and a predetermined unit separation distance.

In another example, the first separation distance and the third separation distance may be set as the product of the transmitting antenna spacing factor and the unit separation distance. In addition, the fourth separation distance and the sixth separation distance may be set as the product of the receiving antenna spacing factor and the unit separation distance.

The unit separation distance may be set based on the frequency of a radar signal. For example, the unit separation distance may be set to half the wavelength (0.5λ) of the frequency of the radar signal or may be an arbitrary number such as 1.5.

In addition, each of the transmitting antenna spacing factor and the receive antenna spacing factor may include two spacing factors.

In an example, the transmitting antenna spacing factor may include a first factor set between the first transmitting antenna and the second transmitting antenna and a second factor set between the third transmitting antenna and the fourth transmitting antenna.

In another example, the receiving antenna spacing factor may include a third factor set between the first receiving antenna and the second receiving antenna and a fourth factor set between the third transmitting antenna and the fourth transmitting antenna.

Each of the first coefficient, the second coefficient, the third coefficient, and the fourth coefficient described above may be set to a predetermined ratio. For example, the ratio of the first coefficient, the second coefficient, the third coefficient, and the fourth coefficient may be set to be N:2N:3N:4N, where N is a real number greater than zero (0).

The present disclosure proposes a structure in which the transmitting antennas 110 and the receiving antennas 120 are arranged such that the first, second, third, and fourth coefficients are set to different numbers, and are set by one-to-one matching in a set of 2N, 3N, 4N, and 8N so that the radar apparatus 100 may have a high angle resolution.

In addition, since the unit separation distance is the same, 2N, 3N, 4N, and 8N may have no unit and may be understood as ratios.

In summary, the first coefficient, the second coefficient, the third coefficient, and the fourth coefficient may be set to different values and be set one-to-one matching in the set of 2N, 3N, 4N, and 8N. For example, the first coefficient, the second coefficient, the third coefficient, and the fourth coefficient may be set to be 2N, 3N, 4N, and 8N, respectively, or 4N, 8N, 2N, and 3N, respectively.

As described above, the transmitting antenna spacing factor and the receiving antenna spacing factor are values intended to represent the spacing of the transmitting antennas and the spacing of the receiving antennas, respectively. Thus, the transmitting antenna spacing factor and the receiving antenna spacing factor may have no unit and may be understood as ratios.

The radar apparatus of the present disclosure has the effect of having high angle resolution by being arranged based on the arrangement structure of the transmitting antennas and the receiving antennas described above.

Reference is made below to the drawings to more visually illustrate the arrangement structures described above. However, this is for ease of understanding only and it will be apparent that arrangement structures not shown below may be implemented by any combination of the various embodiments described above. Accordingly, any combination of the various embodiments described above should be included in the embodiments of the present disclosure.

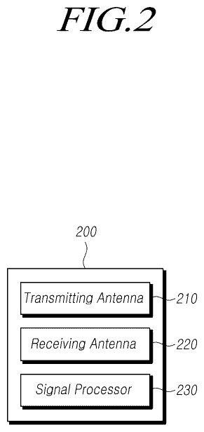

FIG. 2 is a block diagram illustrating a component added to the radar apparatus according to embodiments.

Referring to FIG. 2, the radar apparatus 200 may include a signal processor 230 as a component, in addition to the four transmitting antennas 210 and the four receiving antennas 220.

Specifically, the radar apparatus 200 of the present disclosure may include the signal processor 230 controlling the transmission and reception of radar signals through the plurality of transmitting channels and the plurality of receiving channels and processing the radar signals.

The signal processor 230 of the present disclosure may include a monolithic microwave integrated circuit (MMIC). For example, the MMIC may refer to a single circuit in which active and passive elements are integrated. In addition, the MMIC may include a plurality of transmitting channels and a plurality of receiving channels. Each of the plurality of transmitting channels may be connected to the four transmitting antennas of the present disclosure through respective power lines. Each of the plurality of receiving channels may also be connected to the four receiving antennas of the present disclosure through respective power lines.

In an example, the signal processor of the present disclosure may process signals transmitted by at least two of the four transmitting antennas to be transmitted simultaneously. This includes processing signals transmitted by the four transmitting antennas to be transmitted simultaneously.

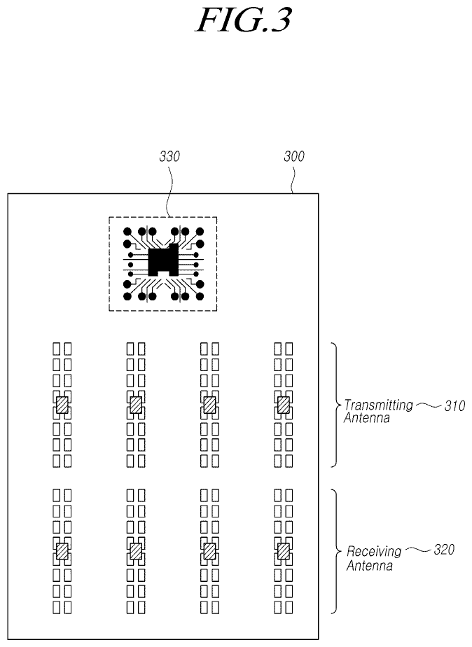

FIG. 3 is a diagram illustrating an implementation of the configuration of the radar apparatus according to embodiments.

Referring to FIG. 3, as described above, the radar apparatus 300 may include transmitting antennas 310, receiving antennas 320, and a signal processor 330.

During target detection, an interference signal may be created depending on the beam pattern of the antenna, and must be removed as desired. This is known as the ambiguity problem caused by a side lobe or a grating lobe.

For example, if the spacing between the centers of the adjacent antennas exceeds the length of the half wavelength of the radar signal transmitted through the antenna channel, a grating lobe may be generated in the beam pattern of the antenna, thereby increasing the ambiguity described above. If the spacing is less than the length of the half wavelength, the grating lobe may be removed, but the size of the aperture of a virtual antenna is reduced. In addition, increasing the size of the antenna aperture without a reference may increase the size of the radar, which is problematic.

Accordingly, as a solution for reducing the above-described ambiguity and to reducing the size of the radar, the present disclosure proposes an antenna arrangement in which each of the number of transmitting antennas and the number of receiving antennas is fixed to four, and the spacing between some of the antennas is set based on the half wavelength.

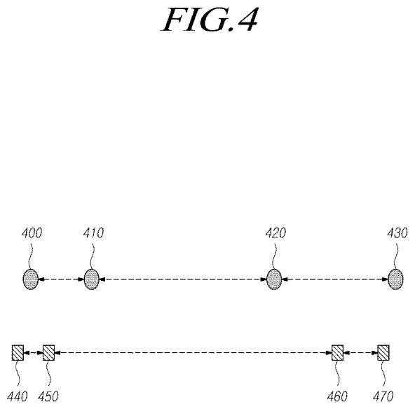

In FIG. 4 and the following figures, embodiments of the antenna arrangement able to create ideal virtual antenna channels having high resolution while overcoming the ambiguity problem described above will be described.

FIG. 4 illustrates an arrangement of transmitting antennas and receiving antenna according to an embodiment.

Referring now to FIG. 4, the four transmitting antennas and the four receiving antennas according to the present disclosure may be arranged on respective straight lines to be spaced apart from each other.

Referring to FIG. 4, the transmitting antennas of the present disclosure include the four transmitting antennas, and the receiving antennas of the present disclosure include the four receiving antennas. In FIG. 4, the positions of the transmitting antennas are indicated by circles, and the positions of the receiving antennas are indicated by squares.

In the present disclosure, the four transmitting antennas may be referred to as a first transmitting antenna 400, a second transmitting antenna 410, a third transmitting antenna 420, and a fourth transmitting antenna 430, which may be spaced apart from each other by predetermined separation distances.

In the present disclosure, the four receiving antennas may be referred to as a first receiving antenna 440, a second receiving antenna 450, a third receiving antenna 460, and a fourth receiving antenna 470, which may be spaced apart from each other by predetermined separation distances.

In an example, the first transmitting antenna 400, the second transmitting antenna 410, the third transmitting antenna 420, and the fourth transmitting antenna 430 may be arranged on a straight line to be spaced apart from each other by predetermined separation distances, and the first receiving antenna 440, the second receiving antenna 450, the third receiving antenna 460, and the fourth receiving antenna 470 may be arranged on a straight line different from the straight line, on which the four transmitting antennas are arranged, to be spaced apart from each other by predetermined separation distances.

In another example, the straight line on which the first transmitting antenna 400, the second transmitting antenna 410, the third transmitting antenna 420, and the fourth transmitting antenna 430 are arranged may be parallel to the straight line on which the first receiving antenna 440, the second receiving antenna 450, the third receiving antenna 460, and the fourth receiving antenna 470 are arranged.

In another example, the first transmitting antenna 400, the second transmitting antenna 410, the third transmitting antenna 420, and the fourth transmitting antenna 430 may be arranged in a region above the straight line on which the first receiving antenna 440, the second receiving antenna 450, the third receiving antenna 460, and the fourth receiving antenna 470 are arranged.

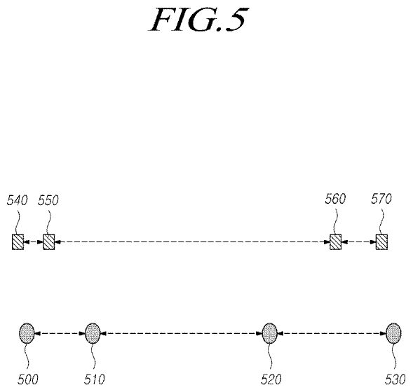

FIG. 5 illustrates an arrangement of transmitting antennas and receiving antenna according to another embodiment.

In the radar apparatus according to embodiments, as shown in FIG. 4, the first transmitting antenna 400, the second transmitting antenna 410, the third transmitting antenna 420, and the fourth transmitting antenna 430 may be arranged in a region above the straight line on which the first receiving antenna 440, the second receiving antenna 450, the third receiving antenna 460, and the fourth receiving antenna 470 are arranged.

In addition, in the radar apparatus according to embodiments, as shown in FIG. 5, a first transmitting antenna 500, a second transmitting antenna 510, a third transmitting antenna 520, and a fourth transmitting antenna 530 may be arranged in a region below a straight line on which the first receiving antenna 540, a second receiving antenna 550, a third receiving antenna 560, and a fourth receiving antenna 570 are arranged.

In summary, as shown in FIG. 4, the first transmitting antenna 400, the second transmitting antenna 410, the third transmitting antenna 420, and the fourth transmitting antenna 430 may be arranged in a region above the straight line on which the first receiving antenna 440, the second receiving antenna 450, the third receiving antenna 460, and the fourth receiving antenna 470 are arranged, or as shown in FIG. 5, the first transmitting antenna 500, the second transmitting antenna 510, the third transmitting antenna 520, and the fourth transmitting antenna 530 may be arranged in a region below the straight line on which the first receiving antenna 540, the second receiving antenna 550, the third receiving antenna 560, and the fourth receiving antenna 570 are arranged.

In the present disclosure, arranging the four transmitting antennas in the region above or below the four receiving antennas, as shown in FIGS. 4 and 5, may be referred to as arranging the four transmitting antennas in a direction perpendicular to the four receiving antennas.

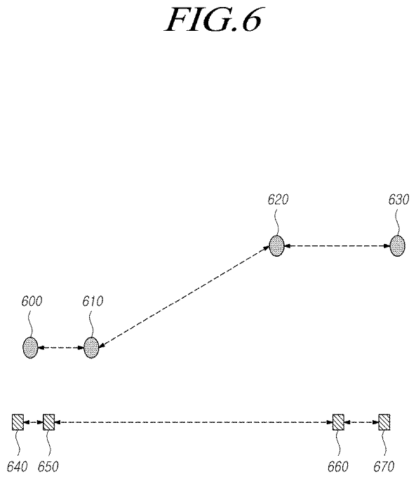

FIG. 6 illustrates an arrangement of transmitting antennas and receiving antenna according to another embodiment.

Referring now to FIG. 6, according to the present disclosure, the four transmitting antennas may be arranged in a two-tiered configuration, rather than being arranged on a straight line as shown in FIGS. 4 and 5.

In an example, two of the four transmitting antennas may be spaced apart from the remaining transmitting antennas by a predetermined vertical spacing in the vertical direction. Here, two of the four transmitting antennas spaced apart from the remaining transmitting antennas by a predetermined vertical spacing means that the two transmitting antennas are vertically offset from the remaining transmitting antennas.

For example, as shown in FIG. 6, the first transmitting antenna 600 and the second transmitting antenna 610 may be arranged to be spaced apart from the third transmitting antenna 620 and the fourth transmitting antenna 620 by a predetermined vertical spacing in the vertical direction. In another example, the first transmitting antenna 600 and the third transmitting antenna 620 may be arranged to be spaced apart from the second antenna 610 and the fourth antenna 630 by a predetermined vertical spacing in the vertical direction.

In addition, as described above, the four transmitting antennas may be arranged in the region above the four receiving antennas, with two of the four transmitting antennas being spaced apart from the remaining transmitting antennas by a predetermined vertical spacing in the vertical direction. The four transmitting antennas may be arranged in the region below the four receiving antennas, with two of the four transmitting antennas being spaced apart from the remaining transmitting antennas by a predetermined vertical spacing in the vertical direction.

In another example, three of the four transmitting antennas may be arranged to be spaced apart from the remaining transmitting antennas by a predetermined vertical spacing in the vertical direction.

For example, the first transmitting antenna 600, the second transmitting antenna 610, and the third transmitting antenna 620 may be arranged to be spaced apart from the fourth transmitting antenna 630 by a predetermined vertical spacing in the vertical direction. In another example, the first transmitting antenna 600, the second transmitting antenna 610, and the fourth transmitting antenna 630 may be spaced apart from the third transmitting antenna 620 by a predetermined vertical spacing in the vertical direction. In another example, the second transmitting antenna 610, the third transmitting antenna 620, and the fourth transmitting antenna 630 may be spaced apart from the first transmitting antenna 600 by a predetermined vertical spacing in the vertical direction.

In addition, as described above, the four transmitting antennas may be arranged in the region above the four receiving antennas, with two of the four transmitting antennas being spaced apart from the remaining transmitting antennas by a predetermined vertical spacing in the vertical direction. The four transmitting antennas may be arranged in the region below the four receiving antennas, with two of the four transmitting antennas being spaced apart from the remaining transmitting antennas by a preset vertical spacing in the vertical direction.

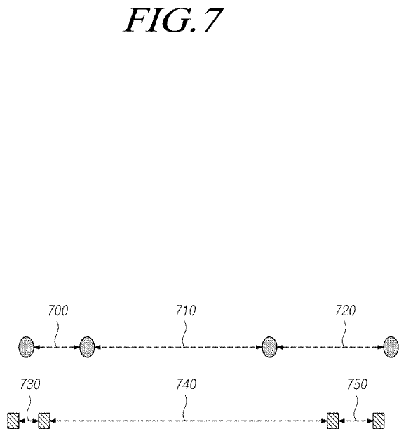

FIG. 7 is a diagram illustrating separation distances of transmitting antennas and receiving antennas according to embodiments.

Referring to FIG. 7, the four transmitting antennas and the four receiving antennas may be arranged to be spaced apart from each other by predetermined separation distances.

In an example, the separation distances according to the present disclosure may include a first separation distance 700 between the first transmitting antenna and the second transmitting antenna, a second separation distance 710 between the second transmitting antenna and the third transmitting antenna, a third separation distance 720 between the third transmitting antenna and the fourth transmitting antenna, a fourth separation distance 730 between the first receiving antenna and the second receiving antenna, a fifth separation distance 740 between the second receiving antenna and the third receiving antenna, and a sixth separation distance 750 between the third receiving antenna and the fourth receiving antenna.

In order to reduce ambiguity caused by a grating lobe or a side lobe and to have a high angle resolution, the present disclosure proposes a method in which the first separation distance, the third separation distance, the fourth separation distance, and the sixth separation distance are set to different values and the predetermined spacings are set to a predetermined ratio.

In an example, the first separation distance 700 and the third separation distance 720 may be set based on a predetermined transmitting antenna spacing factor and a unit separation distance, and the fourth separation distance 730 and the sixth separation distance 750 may be set based on the transmitting antenna spacing factor and the unit separation distance. The second separation distance 710 and the fifth separation distance 740 may be set to various distances as desired.

The unit separation distance may be set to half the wavelength (0.5λ) of the frequency of the radar signal transmitted by the transmitting radars described above. However, this is illustrative only, and the unit separation distance may be variously set to a quarter wavelength (¼λ), a three-quarter wavelength (¾λ), or the like, as desired.

In addition, as described above, the transmitting antenna spacing factors of the present disclosure may include a first factor set between the first transmitting antenna and the second transmitting antenna and a second factor set between the third transmitting antenna and the fourth transmitting antenna, and the receiving antenna spacing factors may include a third factor set between the first receiving antenna and the second receiving antenna and a fourth factor set between the third receiving antenna and the fourth receiving antenna.

In an example, the first coefficient, the second coefficient, the third coefficient, and the fourth coefficient may be set to a predetermined ratio of, for example, 1:1:2:2:2.

In another example, the first factor, the second factor, the third factor, and the fourth factor may be set to different numbers at a predetermined ratio. For example, the first factor, the second factor, the third factor, and the fourth factor may be set to a ratio of 1:2:3:4.

In another example, the first coefficient, the second coefficient, the third coefficient, and the fourth coefficient may be set by one-to-one matching in a set of 2N, 3N, 4N, and 8N (where N is a real number greater than 0).

In another example, the first coefficient, the second coefficient, the third coefficient, and the fourth coefficient may be set to different numbers and be set by one-to-one matching in a set of 2N, 3N, 4N, and 8N (where N is a real number greater than 0).

In another example, the first factor, the second factor, the third factor, and the fourth factor may be set to 2N, 3N, 4N, and 8N, respectively. In another example, the first factor, the second factor, the third factor, and the fourth factor may be set to 4N, 8N, 2N, and 3N, respectively.

In another example, if N is set to 1, and accordingly, the first coefficient, the second coefficient, the third coefficient, and the fourth coefficient are set to 2, 3, 4, and 8, respectively, and the unit separation distance is set to 0.5λ, the first separation distance may be determined to be 1λ, the third separation distance may be determined to be 1.5λ, the fourth separation distance may be determined to be 2λ, and the sixth separation distance may be determined to be 4λ.

The setting methods of the first coefficient, the second coefficient, the third coefficient, and the fourth coefficient are not limited to the methods described above, but may be set variously as needed.

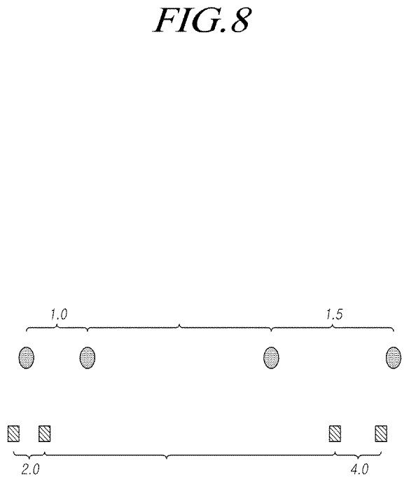

FIG. 8 illustrates separation distances between transmitting antennas and receiving antennas according to embodiments.

Referring to FIG. 8, the four transmitting antennas and the four receiving antennas may be arranged as described above by reflecting a first coefficient, a second coefficient, a third coefficient, and a fourth coefficient that are set to different values, and are set by one-to-one matching in a set of 2N, 3N, 4N, and 8N, where N is a real number greater than 0.

Specifically, in a case in which the first coefficient, the second coefficient, the third coefficient, and the fourth coefficient are set to 2, 3, 4, and 8, respectively, and the unit separation distance is set to 0.5λ, the four transmitting antennas may be arranged on a first straight lines such that the first separation distance is 1.0λ, the third separation distance is 1.5λ, and the fourth separation distance is 2.0λ, and the four receiving antennas may be arranged on a second straight line such that the fourth separation distance is 2.0λ and the sixth separation distance is 4.0λ.

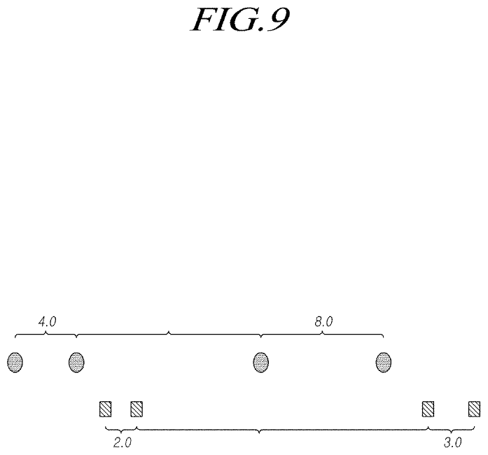

FIG. 9 illustrates separation distances between transmitting antennas and receiving antennas according to embodiments.

Referring to FIG. 9, the four transmitting antennas and the four receiving antennas may be arranged in a different configuration than in FIG. 8.

Specifically, in a case in which the first coefficient, the second coefficient, the third coefficient, and the fourth coefficient are set to 8, 16, 4, and 6, respectively, and the unit separation distance is set to 0.5λ, the four transmitting antennas may be arranged on a first straight line such that the first separation distance is 4.0λ and the third separation distance is 8.0λ, and the four receiving antennas may be arranged on a second straight line such that the fourth separation distance is 2.0λ and the sixth separation distance is 3.0λ.

Accordingly, the present disclosure may provide a radar apparatus having high resolution despite a small arrangement space using the methods described above.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

1. A radar apparatus comprising:
four transmitting antennas comprising first, second, third, and fourth transmitting antennas sequentially arranged by predetermined first, second, and third separation distances; and
four receiving antennas comprising first, second, third, and fourth receiving antennas sequentially arranged by predetermined fourth, fifth, and sixth separation distances,
wherein the predetermined first, third, fourth, and sixth separation distances are set to different numerical values.

2. The radar apparatus of claim 1, further comprising a signal processor controlling transmission/reception of a radar signal through a plurality of transmitting channels and a plurality of receiving channels and processing the radar signal.

3. The radar apparatus of claim 2, wherein the signal processor processes signals transmitted by the four transmitting antennas to be transmitted simultaneously.

4. The radar apparatus of claim 1, wherein the four transmitting antennas and the four receiving antennas are arranged on respective straight lines to be spaced apart from each other.

5. The radar apparatus of claim 4, wherein the straight line on which the four transmitting antennas are be spaced apart from each other is parallel to the straight line on which the four receiving antennas are be spaced apart from each other.

6. The radar apparatus of claim 1, wherein at least two transmitting antennas among the four transmitting antenna are arranged to be spaced apart from the remaining transmitting antennas by a predetermined vertical spacing in a vertical direction.

7. The radar apparatus of claim 1, wherein the four transmitting antennas are arranged in a region above or below the four receiving antennas in a vertical direction.

8. The radar apparatus of claim 1, wherein the first separation distance, the third separation distance, the fourth separation distance, and the sixth separation distance are determined based on a predetermined ratio.

9. The radar apparatus of claim 1, wherein the first separation distance and the third separation distance are set based on a product of a predetermined transmitting antenna spacing factor and a unit separation distance, and
the fourth separation distance and the sixth separation distance are set based on a product of a predetermined receiving antenna spacing factor and the unit separation distance.

10. The radar apparatus of claim 9, wherein the unit separation distance is set to half the wavelength of a frequency of the radar signal transmitted by the transmitting antennas.

11. The radar apparatus of claim 10, wherein the predetermined transmitting antenna spacing factor comprises a first factor set between the first transmitting antenna and the second transmitting antenna and a second factor set between the third transmitting antenna and the fourth transmitting antenna, and
the predetermined receiving antenna spacing factor comprises a third factor set between the first receiving antenna and the second receiving antenna and a fourth factor set between the third receiving antenna and the fourth receiving antenna.

12. The radar apparatus of claim 11, wherein the first, second, third, and fourth factors are set to different numerical values, and
are set by one-to-one matching in a set of 2N, 3N, 4N, and 8N, wherein N is a real number greater than 0.

13. The radar apparatus of claim 12, wherein N is set to be 1.

14. The radar apparatus of claim 12, wherein the first factor is set to 2N, the second factor is set to be 3N, the third factor is set to be 4N, and the fourth factor is set to be 8N.

15. The radar apparatus of claim 12, wherein the first factor is set to 4N, the second factor is set to 8N, the third factor is set to 2N, and the fourth factor is set to 3N.
